(19) United States
(12) Patent Application Publication
(10) Pub. No.: US 2010/0204880 A1
(43) Pub. Date: Aug. 12, 2010

(54) Data Processing Device for an Embedded System

(75) Inventor: David von Oheimb, Grobenzell (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/677,729

(22) PCT Filed: Sep. 8, 2008
(86) PCT No.: PCT/EP08/61882

§ 371 Date: Mar. 11, 2010

(30) Foreign Application Priority Data
Sep. 11, 2007 (DE) 10 2007 043 262.5

(51) Int. Cl. G06F 7/00; G01C 21/00; G06F 21/00

(52) U.S. Cl. 701/35; 726/26; 701/200

(57) ABSTRACT

A data processing device having a security processor for processing data in a manner secure from manipulation and/or a confidential manner. At least one ASIC circuit is connected to the security processor via an internal bus. The ASIC circuit has a plurality of interfaces for connecting peripheral units, and the security processor exchanges data with the peripheral units via the ASIC circuit.

### PRIORITY CLAIM

This is a U.S. national stage of application No. PCT/EP2008/061882, filed on Sep. 8, 2008, which claims Priority to the German Application No: 10 2007 0430262.5, filed: Sep. 11, 2007; the contents of both which are incorporated here by reference.

### BACKGROUND OF THE INVENTION

1. Field of the Invention

The invention relates to a data processing apparatus for an embedded system and particularly a digital tachograph.

2. Prior Art

A tachograph has a speed sensor with a recording instrument that continually records driving periods and rest periods, breaks in driving periods, distance covered by a vehicle, and speeds of said vehicle. The sensed driving periods, working periods, standby periods and rest periods, the breaks therein, and the distances covered are stored in the process. The stored data can be read from the tachograph by a control authority or a transport company. If required, the driver of the vehicle can print out a paper record.

Tachographs are often the subject of manipulation attempts. Usually, attempt is made to reduce the recorded driving periods of the driver or to increase his rest periods so as not to contravene regulations regarding illegal driving periods.

### SUMMARY OF THE INVENTION

An object of the present invention is to provide a data processing apparatus for an embedded system in which data is processed in a manipulation-proof manner in real time and which at the same time can be produced with little complexity.

The invention provides a data processing apparatus having:

a) a security processor for the manipulation-proof and/or confidential processing of data;

b) at least one ASIC circuit which is connected to the security processor by an internal bus, wherein the ASIC circuit has a plurality of interfaces for the connection of peripheral units; and

c) the security processor interchanges data with the peripheral units via the ASIC circuit.

In one embodiment of the data processing apparatus according to the invention, the security processor is connected to the ASIC circuit by a serial bus.

In one embodiment of the data processing apparatus according to the invention, the ASIC circuit performs signal preprocessing and/or signal postprocessing of the interchanged data in real time.

In one embodiment of the data processing apparatus according to the invention, the security processor is a smart card processor.

In one embodiment of the data processing apparatus according to the invention, a peripheral unit is formed by a sensor.

In one embodiment of the data processing apparatus according to the invention, the sensor senses a distance covered by a vehicle.

In one embodiment of the data processing apparatus according to the invention, said data processing apparatus forms a digital tachograph.

### BRIEF DESCRIPTION OF DRAWINGS

Embodiments of the data processing apparatus according to the invention are described below with reference to the accompanying figures to explain features of the invention.

In the figures:

FIG. 1 is a block diagram to illustrate an embodiment of the data processing apparatus according to the invention; and

FIG. 2 is a block diagram of a security processor contained in the data processing apparatus according to an embodiment of the invention.

### DETAILED DESCRIPTION OF THE DRAWINGS

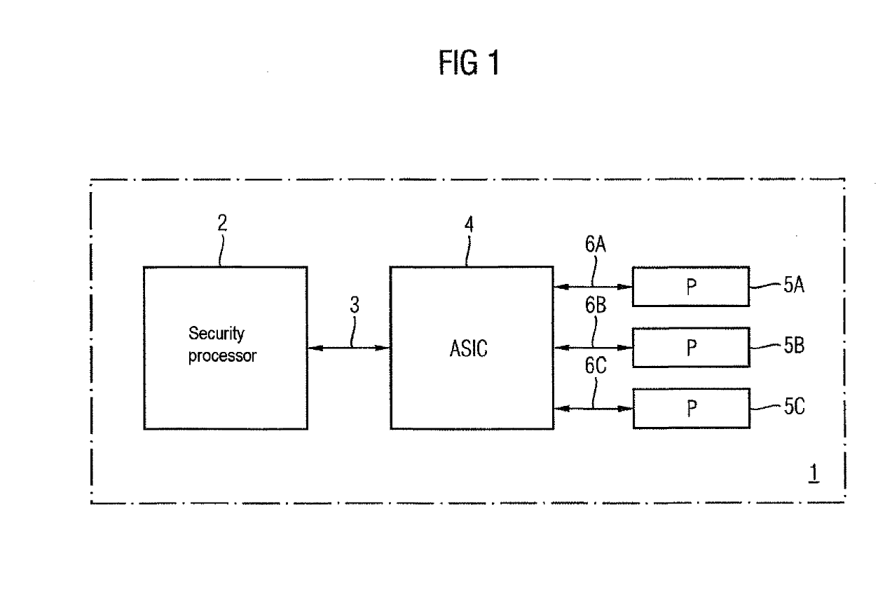

As can be seen from FIG. 1, the data processing apparatus 1 in the exemplary embodiment shown has a security processor 2 which is connected to an application-specific integrated circuit (ASIC) 4 by a narrowband interface, which is formed by a serial bus 3. The ASIC circuit 4 has a plurality of interfaces for the connection of various peripheral units. By way of example the peripheral units 5 are connected to the ASIC circuit 4 by respective serial buses 6A-6C. In the case of the data processing apparatus 1 according to the invention, the security processor 2 exchanges data with the peripheral units 5A-5C via the ASIC circuit 4. The peripheral units 5A-5C include sensors, card readers, key pads, indicator devices, and external memories.

The ASIC circuit 4 has multiplexers and/or demultiplexers that forward the data that is output by the peripheral units 5A-5C to the security processor 2 in clustered form via the serial bus 3. Time-critical input or output operations that require the preprocessing of fast input signals or the postprocessing of specific output signals preferably are executed by the ASIC circuit 4 autonomously. Since the ASIC circuit 4 is a pure hardware circuit which is not controlled by a program, the signal preprocessing and the signal postprocessing of the interchanged data are effected very rapidly, so that the effectiveness or the performance of the data processing apparatus 1 is increased. In one possible embodiment, the signal processing of the ASIC circuit 4 is triggered by the peripheral units 5. By way of example, the signal preprocessing performed by the ASIC circuit 4 is the summation of input signals over time or filter processes, such as moving averaging. By way of example, a radio-frequency transmitter signal is forwarded from the ASIC circuit 4 via the serial bus 3 to the security processor 2 in clustered form at low frequency.

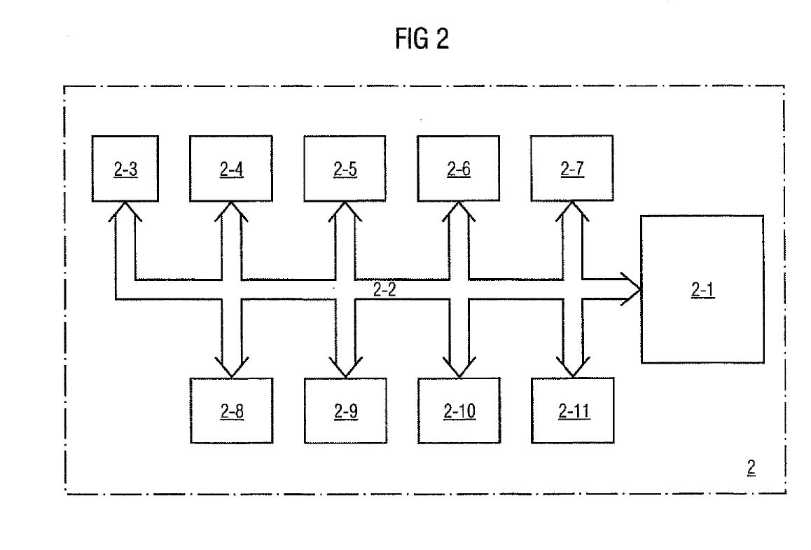

FIG. 2 is a block diagram of a possible embodiment of the security processor 2 configured as a smart card processor. The smart card processor 2 has a CPU 2-1 with a Memory Management Unit MMU, said MMU having what are known as hardware firewalls in order to demarcate applications and system software from one another safely and reliably. By way of example, the CPU 2-1 is a 32-bit CPU which is connected to various units of the smart card processor 2 by means of a 32-bit bus 2-2.

The bus 2-2 has a scalable clock generator 2-3 connected to it for the purpose of generating a clock signal. The generated clock signal is output to the CPU 2-1 via the bus 2-2. Furthermore, the smart card processor 2 has a UART unit 2-4 (Universal Asynchronous Receiver Transmitter). The UART 2-4 can be used to transmit a serial digital data stream bidirectionally. In one possible embodiment, the UART unit 2-4 is connected to the serial bus 3. In addition, the exemplary embodiment shown in FIG. 2 is provided with an EEPROM 2-5 preferably a storage capacity of 400 kbytes. In addition, a data store 2-6 and a hidden ROM store 2-7 are provided for PSL (Platform Support Layer). The PSL has a set of hardware drivers for the peripheral units. By way of example, the ROM store 2-7 has a storage capacity of 80 kbytes.

In addition, the smart card processor 2 shown in FIG. 2 has a 16-bit timer 2-8 and a cryptographic memory 2-9 for storing cryptographic data. By way of example, the memory 2-9 is preferably formed by a ram store with 880 bytes. In addition, a DES (Data Encryption Standard) accelerator 2-10 and a random number generator 2-11 are provided. The MMU (Memory Management Unit) of the processor 2-1 has a virtual address space and is capable of processing various applications in parallel and of executing peripheral functions, such as the external communication via the integrated serial UART interface 2-4. The crypto coprocessors allow the calculations of symmetric and asymmetric algorithms, such as DES, Triple-DES, RSA and elliptic curves. DES is a symmetric encryption algorithm. By way of example, the key length of a DES algorithm is 56 bits and can be increased through multiple use of the DES. An alternative embodiment involves the use of an AES (Advanced Encryption Standard) algorithm.

The smart card processor 2, as shown in FIG. 2 protects the confidentiality and integrity of the processed data. The smart card processor 2 is preferably a certified smart card chip card processor, for example an Infineon SLE88 smart card processor. The ASIC circuit 4 is in the form of a hardware circuit for the data interchange between the smart card processor 2 and the peripheral units 5.

In one embodiment, the ASIC circuit 4 is controlled by the security processor 2 using the serial bus 3.

In one alternative embodiment, the ASIC circuit 4 is controlled by the peripheral units 5 using the interfaces 6. To increase efficiency, the ASIC circuit 4 performs signal preprocessing and signal postprocessing of the interchanged data in real time. This ensures that only necessary data to be protected are transmitted via the serial bus 3.

In one possible embodiment, the data processing apparatus 1 has a plurality of processors 2, at least one of which is a security processor connected to the ASIC circuit 4 by associated serial buses 3. The ASIC circuit 4 contains appropriate multiplexers and demultiplexers for forwarding the data between the security processors 2 and the peripheral units 5.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A data processing apparatus comprising:
an internal bus;
at least one security processor configured to process data in at least one of a substantially manipulation-proof manner and confidential manner; and
at least one ASIC circuit coupled to the at least one security processor via the internal bus, the at least one ASIC circuit having a plurality of interfaces each configured to couple at least one peripheral unit to the at least one ASIC,
wherein the at least one security processor exchanges data with the at least one peripheral unit via the at least one ASIC circuit.

9. The data processing apparatus as claimed in claim 8, wherein the internal bus is a serial bus.

10. The data processing apparatus as claimed in claim 8, wherein the at least one ASIC circuit is configured to perform at least one of signal preprocessing and signal postprocessing of the exchanged data in real time.

11. The data processing apparatus as claimed in claim 8, wherein the at least one security processor is a smart card processor.

12. The data processing apparatus as claimed in claim 8, wherein the peripheral unit comprises a sensor.

13. The data processing apparatus as claimed in claim 12, wherein the sensor senses a distance covered by a vehicle.

14. The data processing apparatus as claimed in claim 13, wherein the data processing apparatus is at least part of a digital tachograph.

15. The data processing apparatus as claimed in claim 8, wherein the data processing apparatus is at least part of a digital tachograph.

16. The data processing apparatus as claimed in claim 8, wherein the at least one security processor comprises at least one of:
a microprocessor;
a clock generator;
a universal asynchronous receiver transmitter;
an EEPROM;
a ROM;
at least one memory;
a platform support layer;
a cryptographic memory;
a random number generator;
a data encryption standard accelerator; and
a memory management unit.

17. The data processing apparatus as claimed in claim 8, further comprising a second security processor coupled to the internal bus.

18. The data processing apparatus as claimed in claim 17, wherein the at least one ASIC comprises a multiplexer and a demultiplexer configured to exchange data between the security processors and the at least one peripheral unit.
